(19) United States
(12) Patent Application Publication
(10) Pub. No.: US 2019/0174668 A1
(43) Pub. Date: Jun. 13, 2019

(54) METHOD AND DEVICE FOR DISTRIBUTING GRANULAR MATERIAL TO MULTIPLE LINES

(71) Applicant: Gerald Funck, Schwaigern-Stetten (DE)

(72) Inventor: Gerald Funck, Schwaigern-Stetten (DE)

(21) Appl. No.: 16/327,175

(22) PCT Filed: Aug. 23, 2017
(86) PCT No.: PCT/EP2017/071254

§ 371 Date: Feb. 21, 2019

(30) Foreign Application Priority Data
Aug. 24, 2016 (DE) 10 2016 010 270.5

(51) Int. Cl. A01C 7/08

(52) U.S. Cl. CPC A01C 7/084

(57) ABSTRACT

The invention relates to a method and a device (01) for distributing granular material to multiple lines (02). According to the method, a mixture flow is first produced by adding a granular material comprising grains to an air flow which is used as a carrier medium. Subsequently, the mixture flow enters a hollow cylindrical distribution chamber (03) with at least one opening (11) in a transfer cross-section (10). In the process, the mixture flow is converted into a bundle, which rotates about a rotational axis (100) that matches the hollow cylindrical axis of the distribution chamber, of a number or a whole-number multiple thereof of sub-flows, each of which is flowing towards the opening (11), said number corresponding to the number of the lines (02) and/or the number of groups of multiple lines (02). Each sub-flow has a sub-flow inlet cross-section in the transfer cross-section, each said sub-flow inlet cross-section passing over the transfer cross-section during a rotation about the rotational axis (100). The granular material is concentrated radially away from the rotational axis (100) within each sub-flow as a result of the rotation of the bundle. Finally, each sub-flow flowing towards the opening (11) reaches a dispensing cross-section (09) which is paired with the sub-flow and in which at least one dispensing opening (08) is arranged that opens into a line (02) or a group of multiple lines (02). Each dispensing cross-section (09) is paired with a line (02) or a group of multiple lines (02). Granular material contained at least in the sub-flows is dispensed into a line (02) and/or or group of multiple lines (02) through the respective dispensing opening (08) by means of the centrifugal forces generated by the rotation. The device (01) comprises means (04) for generating the mixture flow and a distributor housing (06) which houses the rotor (05) that is mounted in a rotatable manner about the rotational axis (100) and receives the hollow cylindrical distribution chamber (03) and which comprises an inlet opening (10) that defines the transfer cross-section, an opening (11), and dispensing openings (08) which are arranged in different dispensing cross-sections (09) lying perpendicularly to the rotational axis (100) and which open into a line (02) or a group of multiple lines (02). The rotor (05) has sector partitions (14) that protrude radially from the rotational axis (100) and divide the distribution chamber (03) into sector channels (15), each of which leads to a dispensing cross-section.

### FIELD OF THE INVENTION

The present invention relates to a method for distributing granular material to a plurality of lines, in particular seed lines, according to the preamble of claim 1, and to a device suitable for carrying out such a method according to the preamble of claim 6.

### PRIOR ART

Effective conservation of resources is achieved in agriculture by means of metering as precisely as possible and by means of positionally-precise placement onto or into the ground during spreading. This applies to substances discharged both in liquid and solid form. For example, when spreading seed, optimal growing space allocation of the individual plants, along with low seed consumption can be achieved in this manner.

For example, with row seeding, which is also known as seed drilling, and with strip tilling and direct seeding, it is necessary to supply seed grains in equal proportions and with a uniform number to multiple parallel sowing furrows or strips. The uniform number here relates to a substantially steady ratio of seed grains supplied to the individual sowing furrows and deposited therein over time.

From field sprayers comprising a plurality of arms projecting transverse to the direction of travel of an agricultural machine, it is common knowledge to temporarily activate and deactivate individual or groups of nozzles individually, for example when these project over an already processed ground section, or the ground section located under said nozzles does not need to be processed.

For distributing substantially granular material comprising grains, for example seed, to a plurality of spreading members or devices, such as sowing coulters, temporary activation and deactivation of individual spreading members is likewise desirable, for example to keep machine tracks free or to avoid uneconomical duplicate grain depositing in the case of overlapping with ground sections on which seed has already been deposited, for example.

To distribute granular material to a plurality of spreading members or devices, for example sowing coulters, it is common knowledge to meter granular material comprising grains from a reservoir, accommodating a supply, into an air flow for example by means or a cellular wheel and/or a Venturi nozzle. The thus obtained mixed flow of the air flow used as the carrier medium and the metered granular material is then fed to a distributor. A plurality of distributor lines branch off from the distributor. Each of these distributor lines leads to spreading members, for example sowing coulters, arranged on one of a plurality of arms projecting, for example, transversely to the direction of travel of an agricultural machine.

Document DE 198 14 030 C1 discloses spreaders for granular material that operate in accordance with the above-described principle, wherein a deflection of the mixed flow leads to an irregular concentration of the granular material at the outer wall of the deflection arc. As a result of this, the uniform distribution of the granular material to the distributor lines branching off from the distributor is disturbed without further intervention since more granular material is fed to distributor lines in the region of high concentration compared to distributor lines in opposite regions of low concentration. This significantly limits design options and leads to large required dimensions for counteracting an irregular concentration of this kind again.

DE 4411 240 C2 discloses the provision of pivotable flaps or vertically moveable slides in a distributor in order to block individual distributor lines branching off from the distributor. In the open position, the flaps or sliders close flush with a wall forming a channel leading to a distributor line, without projecting into the distributor chamber. In this case as well, the shut-off in the distributor changes the concentration of the granular material discharged into the distributor lines that remain open. Switching off can thus ensure neither a constant discharge amount nor an even distribution to the lines remaining open.

DE 102 10 010 A1 discloses the provision of a shut-off in or at the end or at the start of the distributor lines branching off from a distributor, or in the distributor. A shut-off in the distributor allows for a plurality of distributor lines branching off from a distributor to be shut off at the same time in that a slider is slid into a distributor chamber accommodated in the distributor in the direction parallel to the inflow direction of the mixed flow of air flow, used as the carrier medium, and of metered granular material. This slider is arranged at a radial distance with respect to the connections of the distributor lines, said connections branching off from the distributor chamber. For this purpose, the distributor has a greater internal diameter at the connections of the distributor lines to the distributor chamber than in an inlet cross-section of the mixed flow, wherein an annular space remains around the slider, from which the connections of the distributor lines branch off outwardly, as viewed radially with respect to the inflow direction of the mixed flow. The slider has the form of a cylinder concentric with the annular space. The shut-off in the distributor changes the concentration of the granular material discharged into the distributor lines that remain open. By means of the shut-off it is not possible to ensure a constant discharge amount through the lines that remain open.

DE 196 13 785 C2 discloses a spreader in which blocking means are provided in order to prevent, as required, the discharge of granular material to individual or groups of spreading members connected to distributor lines branching off from the distributor. Granular material fed to a shut-off distributor line is discharged via a diversion connection piece. The diversion connection piece is connected to a return line, which feeds the granular material back to the reservoir or mixes same back into the mixed flow.

DE 10 2009 031 066 A1 discloses a distributor comprising a plurality of these branching-off distributor lines. The distributor lines are connected halfway up, spread evenly over the circumference, to a hollow-cylindrical outer ring that is open at its opposing end faces. The outer ring is displaceably arranged concentrically with a hollow-cylindrical distributor housing comprising an inlet opening along its hollow-cylinder axis. In a housing wall connecting the opposed end faces of the distributor housing to each other, discharge windows are arranged in two discharge cross-sections, lying offset along the hollow-cylinder axis, perpendicular to the hollow-cylinder axis and parallel to each other, and in a distributed manner over the circumference, in line with the circumferential positions of the distributor lines, on the outer ring. A number of discharge windows corresponding to the number of distributor lines is arranged in a first discharge cross-section. A smaller number of discharge windows is arranged in a second discharge cross-section. By displacing the outer ring along the hollow-cylinder axis, either the discharge windows of the first discharge cross-section are brought into alignment with the distributor lines connected to the outer ring, wherein a discharge window is associated with each distributor line and thus a discharge takes place to all distributor lines, or the discharge windows of the second discharge cross-section is brought into alignment with just one part of the distributor lines connected to the outer ring, wherein a discharge window is not associated with every distributor line and thus a discharge only occurs to those distributor lines with which a discharge window is associated in the second discharge cross-section.

What is common with the prior art is the unsolved problem of the blocking of branches of the distributor lines from the distributor and/or of the distributor as a whole if individual distributor lines or groups of distributor lines are shut off, this being accompanied by inadequate detection of such a blocking, unsatisfactory assembly conditions both in respect of the required overall dimensions and in respect of a necessary orientation (to be maintained) of the distributor in relation to the branching distributor lines, considerable sensitivity to gravitational influences, inadequate consistency of the concentration of discharged granular material to the active distributor lines when the number of distributor lines that are open or remain open changes, and an inadequate uniform distribution of granular material to the active distributor lines.

### OBJECT

One object of the invention is to provide a method, which overcomes the disadvantages of the prior art, for distributing granular material to a plurality of lines, in particular seed lines, as well as develop a device suitable for carrying out such a method. In particular, one object of the invention is to provide a method and a device for distributing granular material to a plurality of lines which, in conjunction with individual or groupwise disconnection and reconnection as required, enable uniform distribution to lines as well as a uniform discharge amount to the individual lines, for example, leading to spreading members.

### SOLUTION

The above object is achieved by the features of the independent claims. Further advantageous embodiments are described by the dependent claims.

Advantages in relation to the prior art, in addition to a complete solution to the stated problem, are provided by maintaining a uniform concentration of granular material per active distributor line when the proportion of shut-off and open distributor lines changes, and by a particularly high quality of uniform distribution of the granular material to the active distributor lines, accompanied by improved seed distribution and growing space allotment and a lower consumption of granular material.

The invention can comprise one or more of the features mentioned above in relation to the prior art or the documents cited in this regard.

Alternatively or additionally, the method can comprise one or more of the features described in relation to the device, and similarly the device can comprise one or more features described in relation to the device, or can comprise one or more units forming said device.

The invention is explained in greater detail below on the basis of exemplary embodiments illustrated in the drawing. The proportions of the individual elements to each another in the figures do not always correspond to real proportions since some forms are simplified and other forms are shown enlarged in relation to other elements for better illustration. Identical reference symbols are used for identical or identically functioning elements of the invention. Furthermore, for the sake of clarity, only reference signs needed for describing the figure in each case are shown in the individual figures. The illustrated embodiments are only examples of how the separating unit according to the invention can be designed and do not constitute a definitive limitation. The drawings provide a schematic representation:

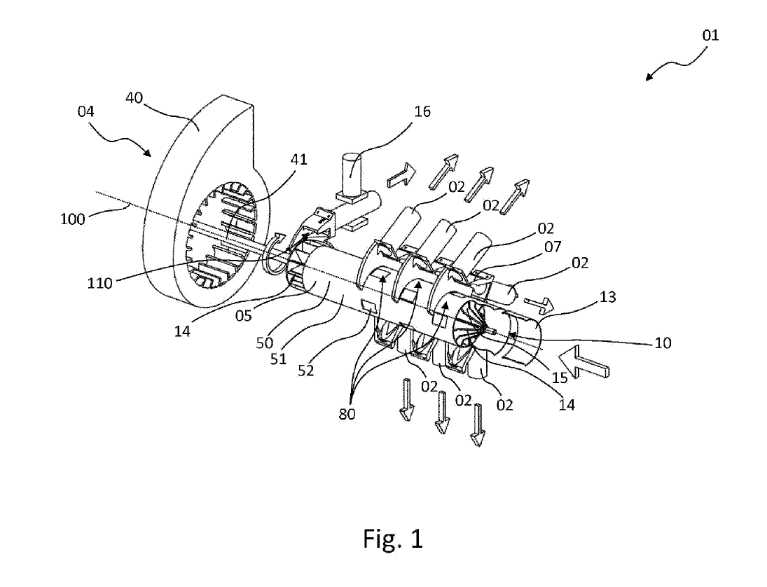

FIG. 1 shows a first exemplary embodiment of a device for distributing granular material to a plurality of lines in perspective view.

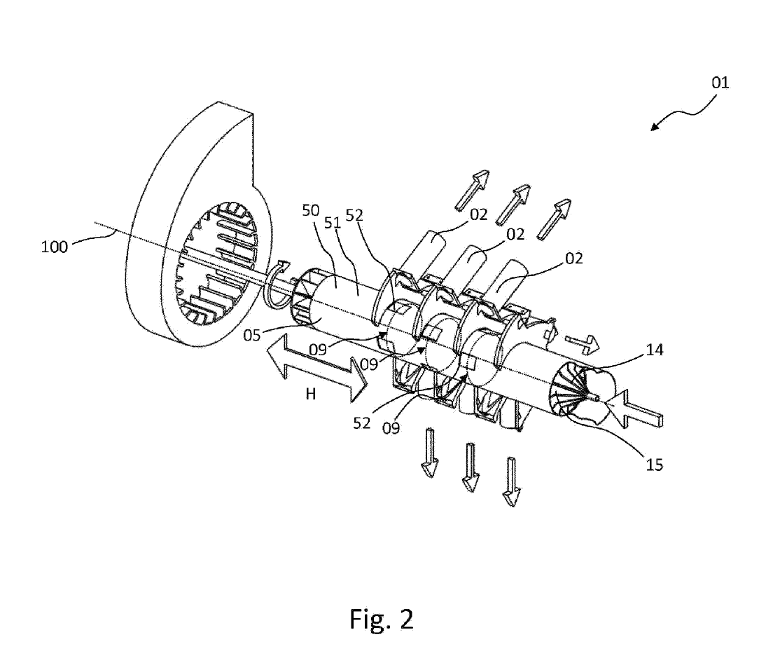

FIG. 2 shows a perspective view of a second exemplary embodiment of a device for distributing granular material to a plurality of lines comprising lines that can be shut off, and a rotor, which for this purpose is longitudinally displaceable along its axis of rotation, in a first operating position of the rotor along the axis of rotation, in which all discharge openings are open.

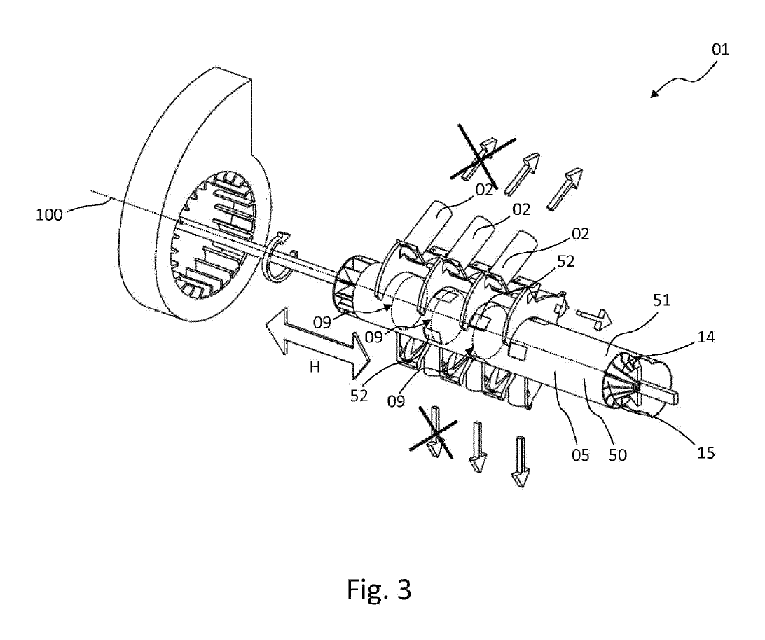

FIG. 3 shows a perspective view of the device from FIG. 2 in a second operating position of the rotor along the axis of rotation, in which the discharge openings associated with one of a total of three discharge cross-sections are shut off and the discharge openings of the remaining two discharge cross-sections are open.

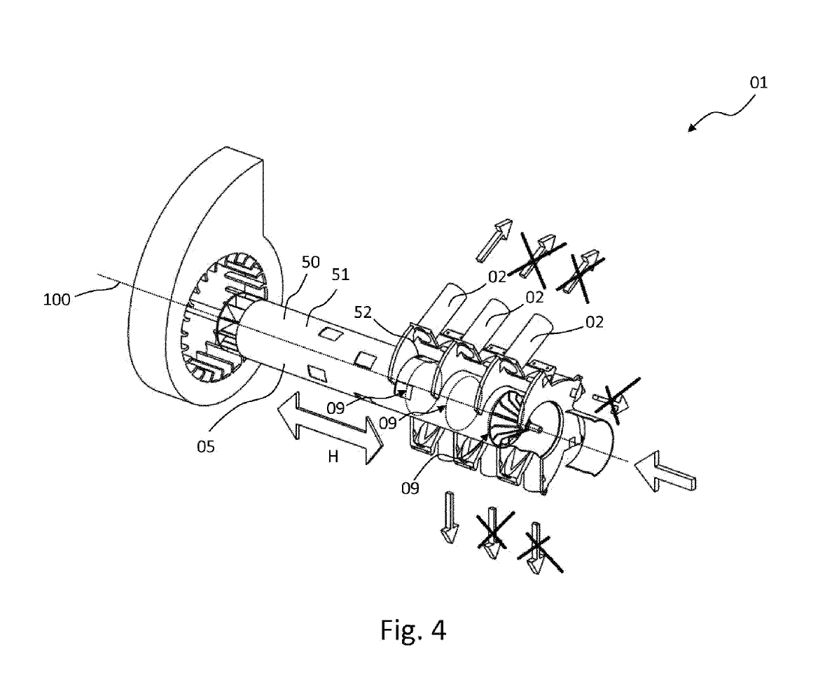

FIG. 4 shows a perspective view of the device from FIG. 2 in a third operating position of the rotor along the axis of rotation, in which the discharge openings associated with two of a total of three discharge cross-sections are shut off and the discharge openings of the remaining one discharge cross-section are open.

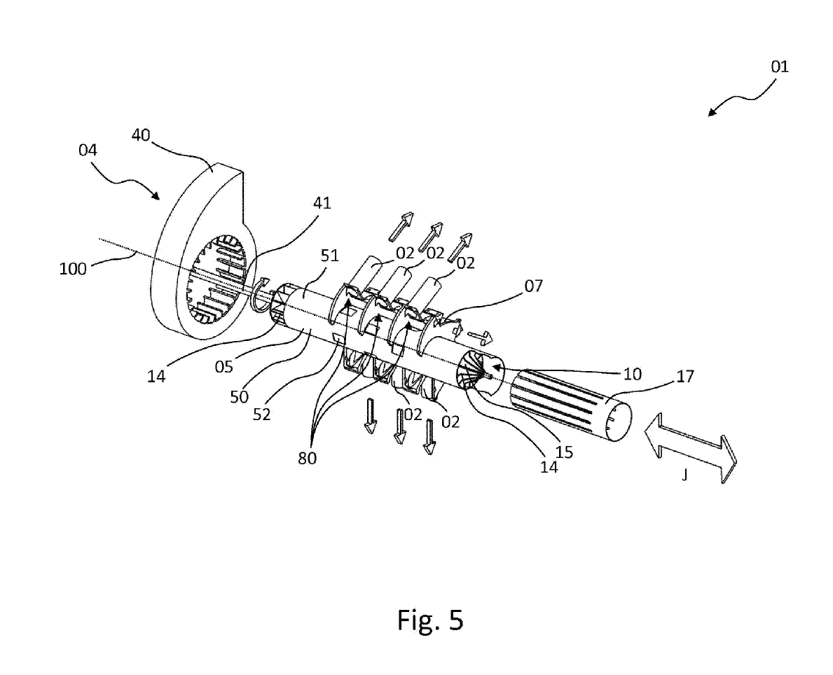

FIG. 5 shows a perspective view of a third exemplary embodiment of a device for distributing granular material to a plurality of lines comprising lines that can be shut off and a slider, which for this purpose is displaceably arranged in a concentric manner with the rotor and parallel to the axis of rotation, in a first operating position of the slider along the axis of rotation, in which all discharge openings are open.

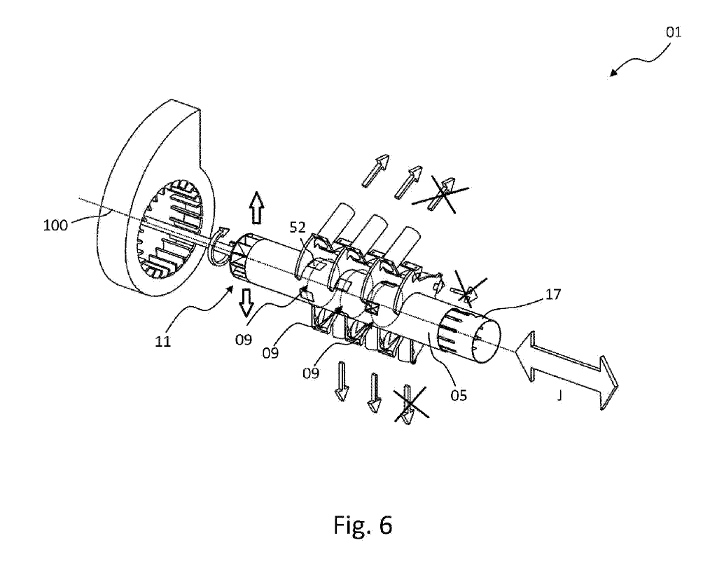

FIG. 6 shows a perspective view of the device from FIG. 5 in a second operating position of the slider along the axis of rotation, in which the discharge openings associated with one of a total of three discharge cross-sections are shut off and the discharge openings of the remaining two discharge cross-sections are open.

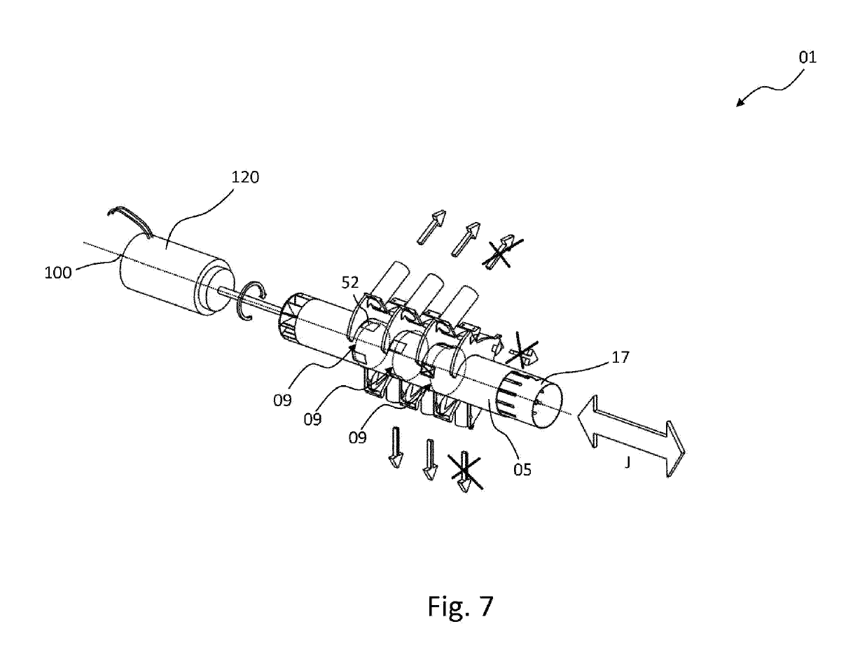

FIG. 7 shows a perspective view of a fourth exemplary embodiment of a device for distributing granular material to a plurality of lines, comprising lines that can be shut off and a slider, which for this purpose is displaceably arranged in a concentric manner with the rotor and parallel to the axis of rotation, in a first operating position of the slider along the axis of rotation, in which the discharge openings associated with one of a total of three discharge cross-sections are shut off and the discharge openings of the remaining two discharge cross-sections are open.

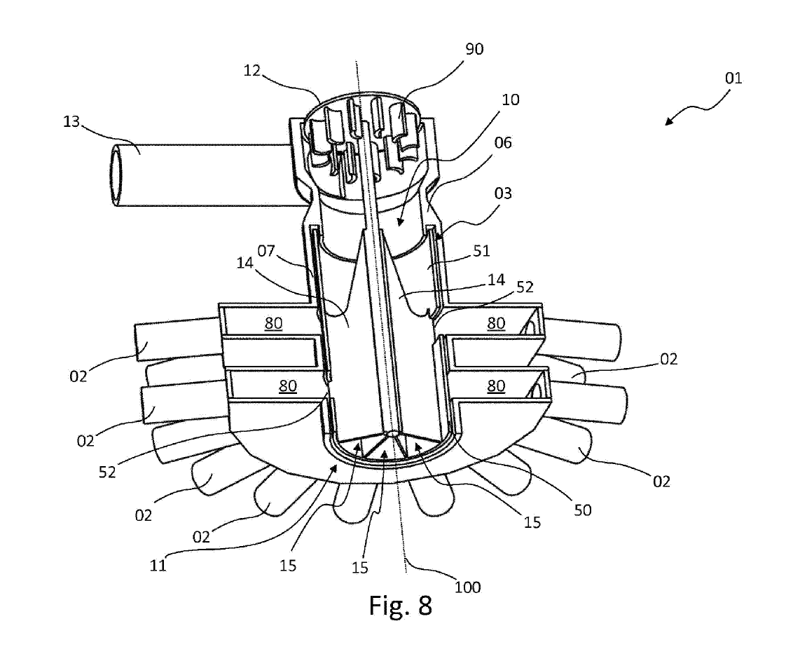

FIG. 8 shows a partial longitudinal section of a fifth exemplary embodiment of a device for distributing granular material to a plurality of lines in perspective view.

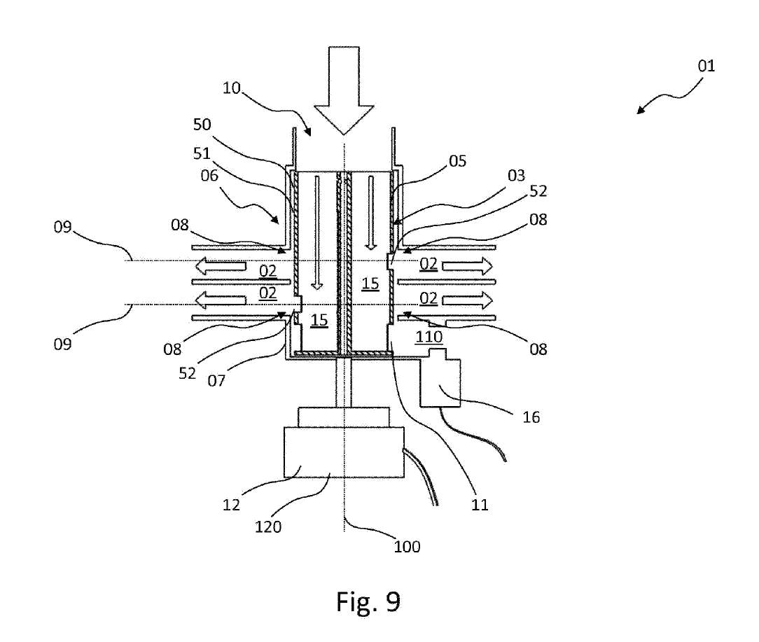

FIG. 9 shows a schematic diagram of a device for distributing granular material to a plurality of lines connected to discharge openings arranged in two discharge cross-sections, in normal operation in a longitudinal section extending along the axis of rotation.

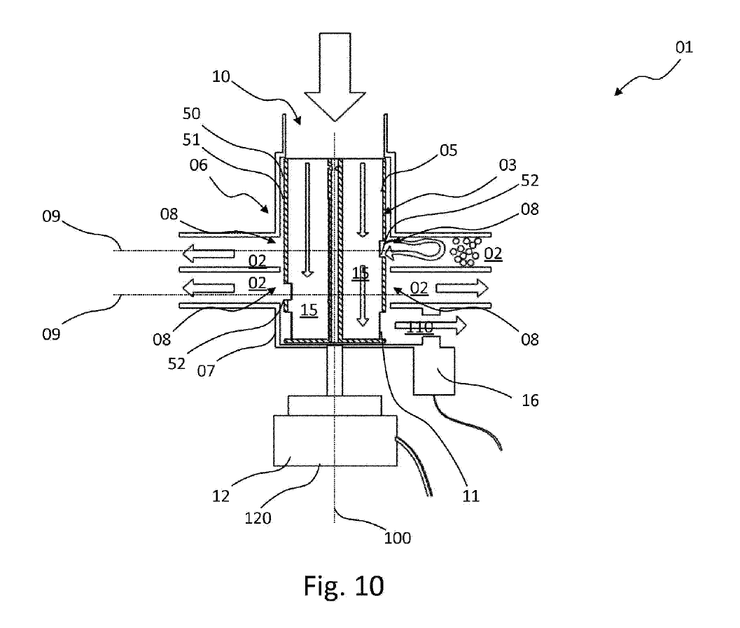

FIG. 10 shows a schematic diagram of a device for distributing granular material to a plurality of lines connected to discharge openings arranged in two discharge cross-sections in the case of a prevailing blockage in a line, in a longitudinal section extending along the axis of rotation.

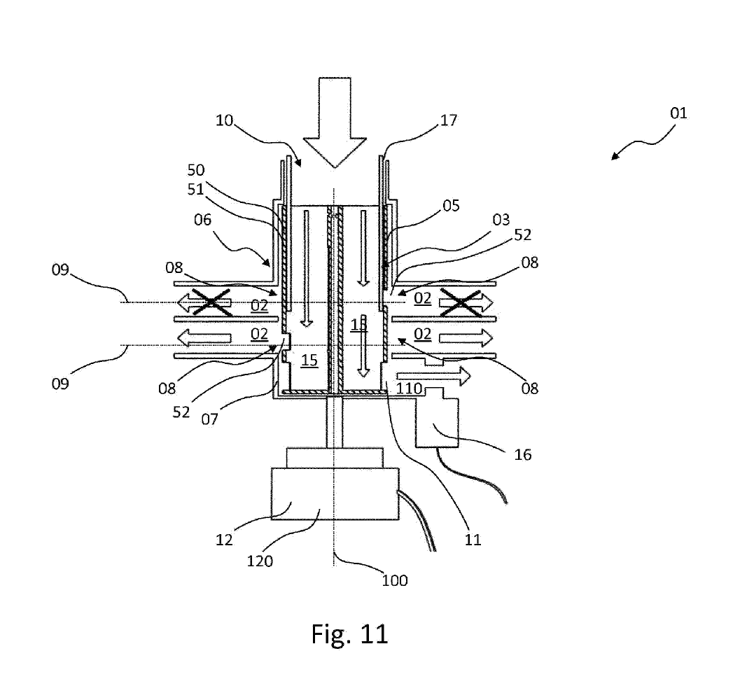

FIG. 11 shows a schematic diagram of a device for distributing granular material to a plurality of lines connected to discharge openings arranged in two discharge cross-sections, comprising lines that can be shut off and a slider, which for this purpose is displaceably arranged in a concentric manner with the rotor and parallel to the axis of rotation, in a first operating position of the slider along the axis of rotation, in which the discharge openings associated with one of two discharge cross-sections are shut off and the discharge openings of the remaining discharge cross-section are open, in a longitudinal section extending along the axis.

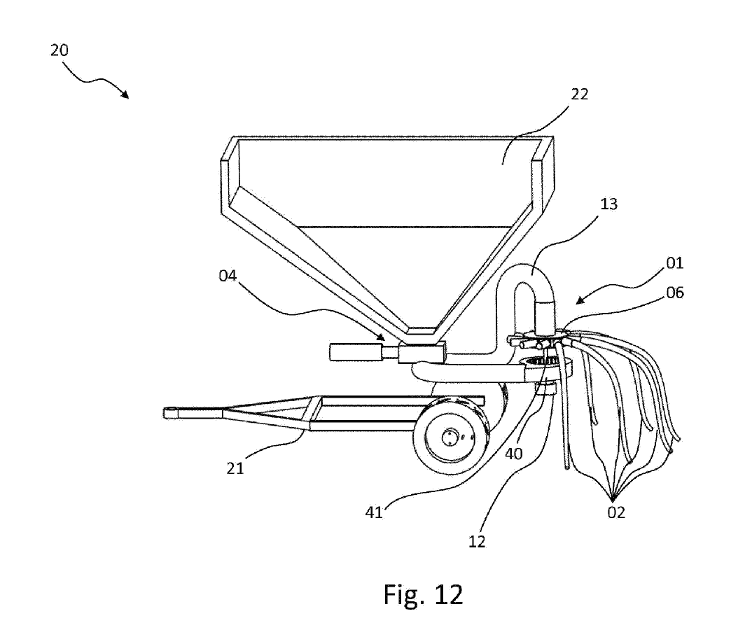

FIG. 12 shows a device for distributing granular material to a plurality of lines as part of a spreader.

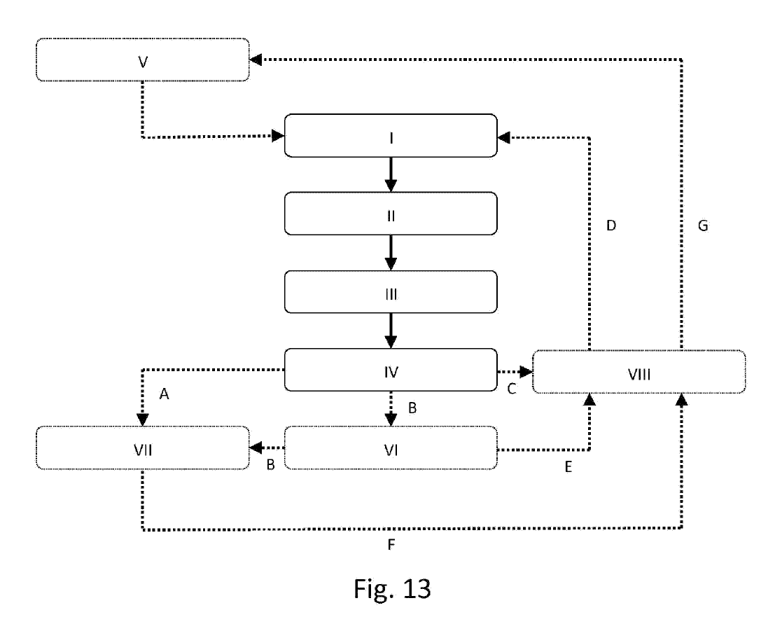

FIG. 13 shows a first flow diagram of a method for distributing granular material to a plurality of lines.

According to a method, the sequence of which is shown in FIG. 13, for distributing granular material to a plurality of lines 02, said lines being formed, for example, by tubes and communicating permanently or in a temporally clocked manner with a distributor chamber, in a first method step I, a mixed flow is generated by adding granular material comprising grains to an air flow used as a carrier medium.

In a second method step II, according to the method, the mixed flow generated previously in the first method step I, in a transfer cross-section, enters a hollow-cylindrical distributor chamber having at least one outlet opening.

The transfer cross-section can span a plane lying, for example, perpendicular to a main flow direction of the mixed flow. In principle, the transfer cross-section can span an area extending arbitrarily in space, for example emulating or occupying part of a cylinder wall.

The hollow-cylindrical distributor chamber has opposite, circular end faces.

The hollow-cylindrical distributor chamber can have a lateral surface connecting the end faces to one another.

The hollow-cylindrical distributor chamber can have a constant but also a varying cross-section parallel to its end faces.

The at least one outlet opening is disposed for example in at least one of the end faces and/or in the vicinity thereof, for example between the lateral surface of the hollow-cylindrical distributor chamber and at least one end face.

If the outlet opening is disposed in an end face or occupies an end face, it can thus span a plane extending perpendicular to the axis of rotation.

If the outlet opening is disposed between the lateral surface of the hollow-cylindrical distributor space and at least one end face, it occupies an annular section, adjacent to an end face, of the lateral surface of the hollow-cylindrical distributor chamber.

The outlet opening can partially or fully occupy an end face and/or an annular section of a lateral surface, for example of the hollow-cylindrical distributor chamber, adjacent to an end face. If the mixed flow enters at or in the vicinity of one of the end faces of the hollow-cylindrical distributor chamber, the least one outlet opening is disposed as far away as possible from the transfer cross-section, for example at or in the vicinity of the end face distant from the transfer cross-section, for example opposite the transfer cross-section.

In the second method step II, the mixed flow upon entry into the distributor chamber is transferred into a bundle of a number or integer multiple thereof of partial flows corresponding to the number of individual lines and/or the number of groups of a plurality of lines, said bundle of partial flows rotating about an axis of rotation coinciding with the hollow-cylinder axis of the distributor chamber, and said partial flows tending toward the outlet opening or at least one outlet opening of the hollow-cylindrical distributor chamber in each case. Here, each partial flow runs within its own sector channel extending on one side along the axis of rotation. Together, all sector channels and sector partition walls separating these channels jointly surround the axis of rotation, wherein each sector channel surrounds the axis of rotation only in part. For example, the sector channels and the partial flows flowing therethrough can run parallel to one another and to the axis of rotation. Here, each partial flow, in the transfer cross-section, has a partial flow inlet cross-section, with each partial flow inlet cross-section of each partial flow sweeping over the transfer cross-section during a revolution of the partial flows, occurring as a result of the rotation of the bundle about the axis of rotation, about the axis of rotation or during a revolution of the bundle.

There is thus no fixed associated location of the partial flow inlet cross-sections in the transfer cross-section. On the contrary, each partial flow inlet cross-section rather occupies every point of the transfer cross-section at least once during a revolution about the axis of rotation. As a result, a uniform distribution of the granular material contained in the mixed flow to the individual partial flows is achieved irrespective of an inhomogeneous concentration of granular material in the mixed flow.

Clearly, as a result of the division of the mixed flow, for example, into partial flows running parallel to one another and parallel to the axis of rotation, tending from the transfer cross-section to the outlet opening and rotating about the axis of rotation, a bundle of partial flows is achieved, wherein the axis of rotation about which the bundle rotates extends in the centre of said bundle. Each partial flow tending from the transfer cross-section to the outlet opening performs a revolution about the axis of rotation during a rotation of the bundle in each cross-section lying between the transfer cross-section and outlet opening.

The bundle of partial flows can widen conically along the axis of rotation from the transfer cross-section to the discharge cross-sections and/or to the outlet opening. With increasing distance from the transfer cross-section along the axis of rotation and increasing proximity to the discharge cross-sections and/or towards the outlet opening, the distance inwards towards the axis of rotation can also increase. In this case, each partial flow runs within a sector of a truncated cone ring.

The partial flows therefore do not run concentrically with one another, but instead each partial flow is offset eccentrically in relation to the axis of rotation and, for example, runs around said axis of rotation parallel thereto.

The mixed flow is transferred into the individual partial flows of the bundle either simultaneously or in a cyclically recurring temporal sequence. A combination is also possible. In the case of the simultaneous transfer, the mixed flow in the transfer cross-section leads into all partial flows of the bundle, or the mixed flow transitions into all partial flows of the bundle. In the case of the cyclically recurring temporal sequence, the mixed flow, considered momentarily, leads only into one partial flow or part of all partial flows of the bundle, or the mixed flow transitions into only one partial flow or one part of all partial flows of the bundle, wherein the mixed flow, as a result of the rotation of the bundle, leads or transitions temporally successively into one partial flow after the other or into one part of all partial flows of the bundle after the other.

The axis of rotation extends centrally through the bundle. The axis of rotation, for example, can run parallel to an above-mentioned main flow direction of the mixed flow prevailing in the transfer cross-section. Alternatively or additionally, the axis of rotation can extend perpendicular to a plane spanned by the transfer cross-section.

The distributor chamber, for the transfer of the mixed flow, may be divided, by means of partition walls rotating about the axis of rotation, into the bundle of partial flows rotating about the axis of rotation.

In other words, the mixed flow in the transfer cross-section, as it enters the hollow-cylindrical distributor chamber, is transferred simultaneously and/or in a cyclically recurring temporal sequence into a number or integer multiple thereof of partial flows corresponding to the number of individual lines and/or the number of groups of a plurality of lines, said partial flows tending toward the outlet opening and revolving in a circle, for example about a common axis of rotation which coincides with the hollow-cylinder axis of the distributor chamber, for example runs parallel to the main flow direction and/or, for example, is arranged perpendicular to a plane spanned by the transfer cross-section, and said partial flows, for example, running parallel to one another and to the axis of rotation, for example divided by partition walls rotating about the axis of rotation, wherein each partial flow in the transfer cross-section has a partial flow inlet cross-section, each partial flow inlet cross-section of each partial flow sweeping over the transfer cross-section during a revolution of the partial flows about the axis of rotation so that there is no fixed associated location of the partial flow inlet cross-sections in the transfer cross-section, but rather each partial flow inlet cross-section occupies each point of the transfer cross-section at least once during a revolution about the axis of rotation.

In principle, outlet openings can also be provided in, on, or towards both opposite end faces. For example, both opposite end faces can be provided with outlet openings or can have outlet openings or can comprise areas spanned by outlet openings.

In the case of outlet openings provided on or at both end faces of the hollow-cylindrical distributor chamber, a first partial flow can tend toward the outlet opening on one end face and the two adjacent partial flows on both sides thereof in the circumferential direction can tend toward the outlet opening on the opposite end face. The transfer cross-section is preferably located here in the middle of the hollow-cylindrical distributor chamber on the inner wall surrounding said chamber.

It is important to highlight in this regard that, in contrast to the term shaft, the term axis in this document describes a geometric axis and not a machine element.

It is likewise important to highlight that the sum of the areas of the partial flow inlet cross-sections of the partial flows can correspond together to the area of the transfer cross-section, wherein the partial flow inlet cross-sections rotate about the axis of rotation in the transfer cross-section. Alternatively, the area of the transfer cross-section can be smaller than at least the sum of the areas of the partial flow inlet cross-sections, wherein the partial flow inlet cross-sections, for example, sweep one after the other over the transfer cross-section during the rotation about the axis of rotation.

In a third method step III according to the method, a concentration of the granular material is generated within each partial flow radially away from the axis of rotation at a wall which surrounds the hollow-cylindrical distributor chamber concentrically with the axis of rotation at least in some sections. This concentration is obtained by the rotation of the bundle about the axis of rotation.

For example, the wall can be an inner wall of an outer ring of a rotor designed at least in some sections as a drum rotor and occupying or forming the distributor chamber.

Alternatively, the wall may be a housing wall of a distributor housing, accommodating a distributor housing interior and a rotor which is mounted therein rotatably about an axis of rotation and occupies the hollow-cylindrical distributor chamber with the hollow-cylinder axis coinciding with the axis of rotation, which housing wall delimits the distributor housing interior radially away from the axis of rotation and surrounds the rotor at least in some sections.

In a fourth method step IV according to the method, finally each partial flow tending toward at least one of the at least one outlet openings reaches, on its way there, a discharge cross-section associated with said partial flow. A line or a group of a plurality of lines is associated with each discharge cross-section. A number of parallel discharge cross-sections corresponding to the number of individual lines or the number of groups of a plurality of lines is thus provided, each of said discharge cross-sections spanning its own plane perpendicular to the axis of rotation. At least one discharge opening leading into a line or into a group of a plurality of lines is arranged in each discharge cross-section in the wall mentioned previously in relation to third method step III. As a result of the centrifugal forces generated by means of the rotation, granular material contained at least in the partial flows is discharged through the discharge opening into a line and/or group of lines.

If a number of partial flows, for example, running parallel to one another and to the axis of rotation and tending toward at least one of the at least one outlet openings of the hollow-cylindrical distributor chamber, said number corresponding to the number of individual lines and/or the number of groups of a plurality of lines, is provided, a discharge cross-section is associated with each partial flow, said discharge cross-section being different from the discharge cross-sections associated with the remaining partial flows. In other words, a partial flow is associated with each discharge cross-section associated with a line and/or a group of a plurality of lines.

If an integer multiple of a number of partial flows, for example, running parallel to one another and to the axis of rotation and tending toward at least one of the at least one outlet openings of the hollow-cylindrical distributor chamber, said number corresponding to the number of individual lines and/or the number of groups of a plurality of lines is provided, a discharge cross-section is associated with each group of a number of partial flows corresponding to the integer multiple. Here as well, the discharge cross-section associated with a group of a number of partial flows corresponding to the integer multiple is different from the discharge cross-sections associated with the remaining groups of a number of partial flows corresponding to the integer multiple in each case. In other words, a number of partial flows corresponding to the integer multiple is associated with each discharge cross-section associated with a line and/or a group of a plurality of lines.

Here, it is important to note that only a partial flow associated with a discharge cross-section can discharge the granular material transported along to the line or group of lines associated with this discharge cross-section.

If a partial flow tending toward the outlet opening or at least one outlet opening sweeps over the at least one discharge opening in the discharge cross-section associated with said partial flow and associated with a line or a group of a plurality of lines during the rotation of the bundle of partial flows about the axis of rotation, the granular material contained in the partial flow is thus fed, jointly with or separately from the air flows used as a carrier medium, through the discharge opening to the line and/or group of lines connected thereto, and is thus discharged into the line and/or group of lines associated with the corresponding discharge cross-section.

At least some of at least the air flow used as a carrier medium can exit here through the outlet opening.

In the event of a blockage and/or shut-off of one or more lines or one or more groups of lines, the partial flow affected or the partial flows affected can exit, together with the granular material transported by said air flows, through the outlet opening.

The discharge amount to the individual lines or groups of a plurality of lines thus remains unaffected even if one or more lines or one or more groups of lines is/are blocked or shut off. A constant discharge amount is thus ensured to the lines remaining open, for example, leading to spreading members.

The method, in a supplementary method step V, shown with dashed lines and to be performed, for example, before the first method step I or after the fourth method step IV or at any point between the first method step I and the fourth method step IV, can provide an individual or groupwise disconnection and reconnection of at least one line and/or at least one group of a plurality of lines as required. To this end, according to the method, the lines leading, for example, to spreading members and/or the discharge openings, to each of which a line or a group of a plurality of lines is connected, can be shut off individually or in groups as required. A partial flow associated with a discharge cross-section is associated with a discharge cross-section having one or more discharge openings leading into a shut-off line and/or into a shut-off group of a plurality of lines and exits through the outlet opening together with the granular material transported by said partial flow.

In the supplementary method step V, one or more lines or one or more groups of a plurality of lines can be shut off and/or reconnected as required as frequently as necessary until the supply of granular material has been used up.

Therefore, according to the method, at least one line and/or at least one group of a plurality of lines and/or the at least one discharge opening, which leads to said at least one line or said at least one group of a plurality of lines or is connected by a line and/or at least one group of a plurality of lines, can be shut off, for example can be closed, as required. A partial flow fed to a discharge cross-section associated with a closed line and/or group and/or discharge opening associated therewith exits through the outlet opening together with the granular material transported by said partial flow.

The shut-off can be provided here at the least one discharge opening of the discharge cross-section associated with a closed line and/or a group of a plurality of lines or in the line or the lines, without influencing a uniform distribution or a consistency of the used amount of granular material in the lines that remain open as a result since a partial flow associated with a discharge opening affected by a shut-off then exits through the outlet opening together with the granular material transported by said partial flow.

Alternatively, the shut-off can be provided in the partial flow inlet cross-section, wherein here, in order to keep consistent the spread amount of granular material in the lines that remain open, the metering of the added granular material comprising grains to the air flow used as a carrier medium has to be changed.

The shut-off is provided particularly preferably by at least one, for example, tubular or tube-section-like slider, which is slid along the axis of rotation over the discharge openings of one discharge cross-section after another. In conjunction with an association of the lines or groups of lines, leading, for example, to spreading members arranged on an arm, for example from the outside inwards and/or from the inside outwards and/or from left to right and/or from right to left on the arm, individual lines or groups of a plurality of lines can thus be shut off and thus closed one after the other temporarily, as required, by moving the slider in and out, and as soon as closure is no longer required, can be opened again and thus brought back into operation for spreading granular material.

According to the method, in an additional method step VI, shown with dashed lines and preferably performed after the fourth method step IV, granular material exiting from the outlet opening is detected, for example by counting the grains. This can be used, for example, to detect a blockage, which, for example, can be used in conjunction with the generation, transmission and output of a signal to stop the operator of a spreader in order to clear the blockage. A resultant advantage is avoided wastage, both of potential growing space and of granular material.

If a rotary angle measurement of the rotor is additionally performed here, it is thus possible to identify the discharge cross-section and thus the line or group of a plurality of lines associated therewith. A blockage can thus be detected and its occurrence and the associated options for clearing it can be indicated precisely.

Particularly advantageously, according to the method, in an optional method step VII occurring, for example, after the fourth method step IV, granular material exiting from the outlet opening is collected. As a result, it is possible for granular material to be handled in a particularly resource-conserving manner. This optional method step VII, as indicated by the arrow A, can take place immediately after the fourth method step IV, or, as indicated by arrow B, after an optionally provided detection of granular material exiting from the outlet opening in an additional method step VI.

Particularly preferably, according to the method, in a further method step VIII, granular material exiting from the outlet opening is added back to the air flow and is supplied to the distribution system.

In addition to particularly resource-conserving handling of granular material, the number of empty journeys until a reservoir carried by a spreader is replenished with a supply of granular material is thus also reduced since, during normal operation, the amount of granular material provided at the feed of a shut-off line is also fed back to the supply and is distributed among the lines remaining open. The supply thus lasts for longer.

A further, optionally provided method step VIII of this kind, shown by dashed lines, can be performed immediately after the fourth method step IV as indicated by arrows C and D, and before the first method step I until the supply of granular material has been exhausted.

If, according to the method, granular material exiting from the outlet opening is added back to the air flow in a further method step VIII and is supplied to the distribution system, and the granular material exiting from the outlet opening is detected in an additional method step VI, the further method step VIII is thus performed only after the additional method step VI, as shown by arrows B and E.

If, according to the method, in an optional method step VII, granular material exiting from the outlet opening is collected, and if, furthermore, granular material exiting from the outlet opening is added back to the air flow in a further method step VIII and is supplied to the distribution system, the further method step VIII, as shown by arrows A and F, is thus performed after the optional method step VII immediately following the fourth method step IV.

In a method according to which granular material exiting from the outlet opening is added back to the air flow in a further method step VIII, this can occur in a supplementary method step V, as required, without any individual or groupwise shut-off and reconnection of at least one line and/or at least one group of a plurality of lines, as shown by an arrow D, or, as required, in conjunction with individual or groupwise shut-off and reconnection of at least one line and/or at least one group of a plurality of lines, as shown by an arrow G. In the supplementary method step V, as already mentioned, one or more lines or one or more groups of a plurality of lines can be shut off and/or reconnected as required as frequently as necessary until the supply of granular material has been used up.

An above-described method can be implemented by a device 01 for distributing granular material to a plurality of lines 02 formed, for example, at least partially by tubes, said device being shown wholly or partially in FIGS. 1, 2, 3, 4, 5, 6, 7, 8, 9, 10, 11 and 12 and suitable for carrying out an above-described method.

The device 01 for distributing granular material to a plurality of lines 02 formed, for example, by tubes comprises means 04 for generating a mixed flow of an air flow used as a carrier medium and granular material added to said air flow, said means for example comprising a unit for generating an air flow, such as a fan 40, and a unit for adding granular material to the air flow, for example comprising a cellular wheel and/or a Venturi nozzle.

The device 01 additionally comprises a distributor housing 06 accommodating a rotor 05 mounted rotatably about an axis of rotation 100.

The distributor housing 06 has a housing wall 07 surrounding the rotor 05 at least in some sections.

The distributor housing 06 has an inlet opening 10 spanning a transfer cross-section, and at least one outlet opening 11.

The inlet opening 10 can be provided on at least one of the two end faces of the distributor housing 06 which are arranged opposite along the axis of rotation 100. The outlet opening 11 can be provided on the opposite end face, as shown in FIG. 8, or can be arranged as an annular, radial outlet at the transition between an end face and a lateral surface connecting the opposite end faces to one another and formed, for example, by the housing wall 07, as shown in FIGS. 1, 2, 3, 4, 5, 6, 7, 9, 10 and 11.

The rotor 05 occupies a hollow-cylindrical distributor chamber 03 having a hollow-cylinder axis which coincides with the axis of rotation 100. A number of discharge openings 08 corresponding to the number of lines 02 and/or the number of groups of a plurality of lines 02 are arranged in the housing wall 07 in different discharge cross-sections 09 arranged perpendicular to the axis of rotation 100. Here, each line 02 or each group of a plurality of lines 02 is associated with its own discharge cross-section 09 arranged perpendicular to the axis of rotation 100.

For example, a group of a plurality of lines 02 can be formed by lines 02 connected to a plurality of discharge openings 08 situated in the same discharge cross-section 09, as is the case in the at least two different discharge cross-sections 09 in each of the devices 02 shown in FIGS. 1, 2, 3, 4, 5, 6, 7, 8, 9, 10 and 11.

Each discharge cross-section 09 associated with a line 02 or a group of a plurality of lines 02 is different from the discharge cross-sections 09 associated with the remaining lines 02 or a group of a plurality of lines 02. The different discharge cross-sections 09 associated with the different lines 02 groups of a plurality of lines 02 are arranged in parallel with one another in an offset manner along the axis of rotation 100.

A line 02 or a group of lines 02 is connected or can be connected to each discharge opening 08.

The device 01 additionally has suitable drive means 12, for example, connected or connectable to the rotor 05 so as to set the rotor 05 in rotation about the axis of rotation 100.

The device 01 also has a feed line 13 connecting the means 04 for generating the mixed flow to the inlet opening 10.

The device 01 is characterised in that the rotor 05 has a number or integer multiple thereof of sector partition walls 14, said number or integer multiple thereof corresponding to the number of lines 02 and/or the number of groups of a plurality of lines 02, said sector partition walls protruding radially from the axis of rotation 100 and dividing the hollow-cylindrical distributor chamber 03 into a number or integer multiple thereof of sector channels 15, said number of integer multiple thereof corresponding to the number of individual lines 02 and/or the number of groups of a plurality of lines 02, said sector channels jointly surrounding the axis of rotation 100, each running along the axis of rotation 100 on one side, for example parallel to one another, extending circumferentially about the axis of rotation 100 when the rotor 05 is rotated, and for example being in the form of circular cylinder sectors and therefore in the form of wedges of cake.

Each sector channel 15 extends on one side from the axis of rotation 100 and along said axis.

Together, all sector channels and sector partition walls 14 separating said channels jointly surround the axis of rotation 100 in a bundle-like manner, wherein each sector channel 15 surrounds the axis of rotation 100 only in part.

The sector channels 15 separated from one another by the sector partition walls 14 transfer the mixed flow entering the hollow-cylindrical distributor chamber 03 in the transfer cross-section into a bundle of partial flows rotating about the axis of rotation 100.

Each sector channel 15 divides a partial flow from the mixed flow. A partial flow of the mixed flow flows through each sector channel 15. Each partial flow runs within its own sector channel 15.

For example, the sector channels 15 and the partial flows flowing therethrough can thus also run parallel to one another and to the axis of rotation 100.

The bundle of sector channels 15 can widen conically along the axis of rotation 100 from the inlet opening 10 to the discharge cross-sections 09 and/or to the outlet opening 11. With increasing distance from the inlet opening 10 along the axis of rotation 100 and increasing proximity to the discharge cross-sections 09 and/or towards the outlet opening 11, the distance inwards towards the axis of rotation 100 can also increase. In this case, the sector channels 15 extend within a truncated cone ring.

The sector channels 15 in principle can have any cross-sectional form perpendicular to the axis of rotation 100. The cross-sectional form is provided here in principle by the shaping of the sector partition walls 14.

The rotor 05 can be open towards one end face or towards both end faces of the distributor housing 06, which are arranged opposite along the axis of rotation 100, and towards the at least one outlet opening 11 arranged, for example, in at least one of the end faces.

The rotor 05 can protrude from the distributor housing 06 through the outlet opening 11. Here, the rotor 05 cannot eject granular material, discharged to the lines 02 or groups of a plurality of lines 02 connected to the discharge openings 08, radially away from the axis of rotation 100 via said discharge openings.

The drive means 12 can comprise an independent drive motor 120, by means of which the motor shaft of the rotor 05 is directly or indirectly connected via a transmission. Alternatively, the drive means 12 can comprise a connection of the rotor 05 to a motor, for example a unit for generating an air flow, such as a fan 40, of the means 04 for generating the mixed flow. A connection of this kind can be produced by a connecting shaft 41.

The rotor 05 can be formed at least in some sections as a star rotor which is open radially outwards away from the axis of rotation 100 and has sector partition walls 14 which separate the adjacent sector channels 15 from one another and protrude radially from the axis of rotation 100.

The sector partition walls 14 can be formed here fixedly, for example by plate-like wall elements protruding radially from the axis of rotation 100, or can be formed resiliently—this being gentle on the granular material—for example at the entry to the rotor 05, for example by means of brush-like bristle rows protruding radially from the axis of rotation 100.

Alternatively or additionally, the rotor 05 can be designed at least in sections as a drum rotor 50 closed radially outwards away from the axis of rotation 100, having a hollow-cylindrical, tubular or tube-section-like outer ring 51 or an outer ring wall, and having sector partition walls 14 which separate the adjacent sector channels 15 from one another and protrude radially from the axis of rotation 100 to the outer ring 51.

The outer ring 51 is provided in each case with a discharge window 52 per sector channel 15. The discharge windows 52 are arranged in an offset manner along the axis of rotation 100 according to the association of the sector channels 15 with the various discharge cross-sections 09.

Discharge windows 52, offset along the axis of rotation 100 and each associated with a sector channel 15, are therefore arranged in the outer ring 51 or in the outer ring wall in the various discharge cross-sections 09 for the individual sector channels 15, and in an offset manner along the axis of rotation 100 according to the discharge openings 08 arranged in the various discharge cross-sections 09 in the housing wall 07.

Alternatively, the rotor 05 can thus be designed as a drum rotor 50, closed radially outwards away from the axis of rotation 100, having a hollow-cylindrical outer ring 51 provided with discharge windows 52 arranged according to the various discharge cross-sections 09 of its sector channels 15, and having sector partition walls 14 which separate the adjacent sector channels 15 from one another and protrude radially from the axis of rotation 100 to the outer ring 51. Discharge windows 52 of the sector channels 15 are arranged in an offset manner in the outer ring 51 according to the various discharge cross-sections 09 along the axis of rotation 100.

If the discharge window 52 of a sector channel 15 sweeps over a discharge opening 08 associated with this sector channel 15 by matching the discharge cross-section 09 during the rotation of the drum rotor 50 about the axis of rotation 100, said discharge opening being connected by a line 02 or a group of a plurality of lines 02, at least the granular material transported by a partial flow flowing through the corresponding sector channel 15 is discharged to this line 02 or this group of a plurality of lines 02.

The drum rotor 50 here surrounds or forms the distributor chamber 03. The drum rotor 50 itself is arranged rotatably about the axis of rotation 100 in a distributor housing interior accommodated in a distributor housing 06 and which itself can be hollow-cylindrical with a hollow-cylinder axis extending along the axis of rotation 100, or which in the individual discharge cross-sections 09 can have a geometry which, when swept over by a discharge window 52 during a revolution of the drum rotor 50 about the axis of rotation 100, widens, for example, continuously towards a discharge chamber 80 and, for example, transitions a connected line 02 tangentially to the direction of rotation. For example, the connection of the line 02 to the discharge chamber 80 can form the discharge opening 08, or an outlet cross-section of a line 02 connected to a discharge chamber 80 can form a discharge opening 08.

In order to shut off individual lines 02 or groups of a plurality of lines 02 by closing the discharge openings 08 or windows 52 of a discharge cross-section 09 one after the other, the rotor 05, as indicated in FIGS. 2, 3 and 4 by double-headed arrows H, and/or, as shown in FIGS. 5, 6 and 7 by double-headed arrows J, a slider 17 arranged concentrically with the rotor 05 and having a tubular or tubular portion-shaped form can be movably arranged parallel to the axis of rotation 100.

For example, the inner diameter of a slider 17, arranged movably parallel to the axis of rotation 100 in order to shut off individual lines 02 or groups of a plurality of lines 02, can correspond substantially to an outer diameter of the rotor 05. The slider 17 in this case can be introduced between the rotor 05 and the housing wall 07 into a distributor housing interior enclosed by the distributor housing 06.

Alternatively, as shown in FIGS. 5, 6 and 7, the outer diameter of a slider 17 arranged movably parallel to the axis of rotation 100 in order to shut off individual lines 02 or groups of a plurality of lines 02 can match the inner diameter of the outer ring 51 of a rotor 05 in the form of a drum rotor 50. The slider 17 provided with longitudinal slots for the sector partition walls 14 is slid here into the inside of the rotor 05 and closes, in succession, the discharge windows 52 of a discharge cross-section 09 arranged in the outer ring 51.

Alternatively or in addition to a shut-off by a slider 17 formed in a tubular or tube-section-like manner and movable along the axis of rotation 100, the rotor 05, when in the form of a drum rotor 50, can be arranged longitudinally displaceably along the axis of rotation 100, as indicated in FIGS. 2, 3 and 4 by double-headed arrows H. As a result, a new association of the discharge windows 52 of the sector channels 15 and of the discharge cross-sections 09 defined by the discharge openings 08 associated with the individual lines 02 or groups of a plurality of lines 02 is obtained, likewise in order to shut off individual lines 02 or groups of a plurality of lines 02. The discharge windows 52 of a sector channel 15 can be slid out here in succession from the region of the housing wall 07 of the distributor housing 06, or of a distributor housing interior surrounded by said housing, provided with discharge openings 08 defining discharge cross-sections 09. Portions of the rotor 05 in which there are no discharge windows 52 in the outer ring 51 thus overlap the discharge openings 08 of a discharge cross-section 09 in succession. A sector channel 15 which was associated previously with one or more discharge openings 08 of a discharge cross-section 09 other than the one considered last in the displacement direction now discharges the granular material, transported by the partial flow flowing through said sector channel, through discharge openings 08 associated with the next discharge cross-section 09. A partial flow flowing through a sector channel 15 and associated previously with one or more discharge openings 08 of a discharge cross-section 09 considered last in the displacement direction, by contrast, exits through the outlet opening 11 together with the granular material transported by said partial flow.

Granular material discharged through the outlet opening 11 can be detected, for example, by means of a sensor 16 arranged, for example, at the outlet opening 11 or in a collection channel 110 adjoining the outlet opening 11 and shown in FIGS. 1, 9, 10 and 11.

By measuring the rotary angle of the rotor 05, not only can a blockage be detected or a shut-off confirmed, but it is also possible to determine which sector channel 15 and therefore which discharge cross-section 09 is blocked or shut off.

As already mentioned, the distributor housing 06 can accommodate a distributor housing interior. The housing wall 07 delimits such an, optionally provided, housing interior radially away from the axis of rotation 100. The hollow-cylindrical distributor chamber 03 occupied by the rotor 05 occupies the optionally provided distributor housing interior, at least in part.

It is important to note that a unit already provided, for example a fan 40 of the means 04 for generating the mixed flow, can be coupled to the rotor 05 in order to drive the rotor 05. To this end, a connecting shaft 41 can be provided between the fan 40 and the rotor 05, as shown in FIGS. 1 to 6 and in FIG. 12.

Alternatively, as shown in FIGS. 7, 9, 10 and 11, a separate drive motor 120 can be provided, the output shaft of which sets the rotor in rotation about the axis of rotation.

An additional variant is shown in FIG. 8. This utilises the air flow of the mixed flow or a partial air flow branched off from a unit for generating an air flow of the means 04 for generating the mixed flow, in order to drive the rotor 05. To this end, a turbine 90, of tangential design in the exemplary embodiment shown in FIG. 8, is connected to the rotor 05 or is coupled thereto via a connecting shaft.

According to method that can be carried out by means of an above-described device 01, a mixed flow is firstly generated by adding granular material comprising grains to an air flow used as a carrier medium. The mixed flow then, in a transfer cross-section 10, enters a hollow-cylindrical distributor chamber 03 comprising at least one outlet opening 11. Here, the mixed flow is transferred into a bundle, rotating about an axis of rotation 100 which coincides with the hollow-cylinder axis of the distributor chamber, of a number or integer multiple thereof of partial flows, said number of integer multiple thereof corresponding to the number of lines 02 and/or the number of groups of a plurality of lines 02, said partial flows, for example, running parallel to one another and to the axis of rotation 100 and tending towards the outlet opening 11. Each partial flow in the transfer cross-section has a partial flow inlet cross-section, which in each case sweeps over the transfer cross-section during a revolution about the axis of rotation 100. As a result of the rotation of the bundle, a concentration of the granular material is then generated within each partial flow, radially away from the axis of rotation 100. Lastly, each partial flow tending towards the outlet opening 11 reaches a discharge cross-section 09 associated with said partial flow, in which discharge cross-section at least one discharge opening 08 is arranged which leads into a line 02 or a group of a plurality of lines 02. A line 02 or a group of a plurality of lines 02 is associated with each discharge cross-section 09. As a result of the centrifugal forces generated by means of the rotation, granular material contained at least in the partial flows is discharged through the discharge opening 08 into a line 02 and/or group of a plurality of lines 02.

Both the method and a device 01, for example in conjunction with a reservoir for storing granular material comprising grains and adding granular material taken from this reservoir to an air flow, make it possible to even out the distribution to a plurality of lines 02 that can be shut off and reconnected individually or in groups.

The device 01 is intended in particular for use in conjunction with a spreader 20 for granular material, such as a sowing machine.

An exemplary embodiment of a spreader 20 for granular material is shown in FIG. 12. For the sake of clarity, however, no spreading members have been shown at the ends of the lines 02.

The spreader 20 comprises a funnel-shaped supply container 22 arranged on an undercarriage 21 and accommodating a reservoir of granular material comprising grains. Means 04 for generating a mixed flow of a device 01 for distributing granular material to a plurality of lines 02 are arranged at the end of the funnel beneath the supply container 22. A connecting shaft 41 couples the rotor 05 accommodated in the distributor housing 06 to a unit, in the form of a fan 40, for generating an air flow of the means 04 for generating a mixed flow. The drive means 12 of the device 01 comprise the motor of the fan 40 and the connecting shaft 41.

The invention is industrially applicable, particularly in the field of manufacturing agricultural machinery and units, especially spreaders, such as sowing machines, particularly for drill or mulch seeding, and/or for fertiliser distributing machinery and distributor devices for such distributing machinery.

The invention has been described with reference to a preferred embodiment. However, it is conceivable to a person skilled in the art for modifications or changes to be made to the invention without departing from the scope of protection of the claims below.

### LIST OF REFERENCE SIGNS

01 Device
02 Line
03 Distributor chamber
04 Means for generating a mixed flow
05 Rotor
06 Distributor housing
07 Housing wall
08 Discharge opening
09 Discharge cross-section
10 Inlet opening
11 Outlet opening
12 Drive means
13 Feed line
14 Sector partition wall
15 Sector channel
16 Sensor
17 Slider
20 Spreader
21 Undercarriage
22 Supply container
40 Fan
41 Connecting shaft
50 Drum rotor
51 Outer ring
52 Discharge window
80 Discharge chamber
90 Turbine
100 Axis of rotation
110 Collection channel
120 Drive motor
I Method step
II Method step
III Method step
IV Method step
V Method step
VI Method step
VII Method step
VIII Method step
A Arrow
B Arrow
C Arrow
D Arrow
E Arrow
F Arrow
G Arrow
H Double-headed arrow
J Double-headed arrow

1. A method for distributing granular material to a plurality of lines (02), wherein:
firstly, a mixed flow is produced by adding granular material comprising grains to an air flow used as the carrier medium,
the mixed flow then, in a transfer cross-section (10), enters a hollow-cylindrical distributor chamber (03) comprising at least one outlet opening (11) and in so doing is transferred into a bundle, rotating about an axis of rotation (100) coinciding with the hollow-cylinder axis of the distributor chamber, of a number or integer multiple thereof of partial flows corresponding to the number of lines (02) and/or the number of groups of a plurality of lines (02), said partial flows each tending toward the outlet opening (11), wherein each partial flow in the transfer cross-section has a partial flow inlet cross-section, each of which sweeps over the transfer cross-section during a revolution about the axis of rotation (100),
as a result of the rotation of the bundle, a concentration of the granular material is then generated within each partial flow, radially away from the axis of rotation (100), and
lastly, each partial flow tending toward the outlet opening (11) reaches a discharge cross-section (09) which is associated with the partial flow and in which at least one discharge opening (08) leading into a line (02) or a group of a plurality of lines (02) is arranged, wherein a line (02) or a group of a plurality of lines (02) is associated with each discharge cross-section (09), and wherein, as a result of the centrifugal forces generated by means of the rotation, at least granular material contained in the partial flows is discharged through the discharge opening (08) into a line (02) and/or group of a plurality of lines (02).

2. The method according to claim 1, wherein at least one line (02) and/or at least one group of a plurality of lines (02) and/or the at least one discharge opening (08) leading into said line or group of a plurality of lines can be shut off, wherein a partial flow with which a discharge cross-section (09) having one or more discharge openings (08) leading into a shut-off line (02) and/or into a shut-off group of a plurality of lines (02) is associated exits through the outlet opening (11) together with the granular material transported by said partial flow.

3. The method according to claim 1, wherein granular material exiting from the outlet opening (11) is detected.

4. The method according to claim 1, wherein granular material exiting from the outlet opening (11) is collected.

5. The method according to claim 1, wherein granular material exiting from the outlet opening (11) is again added to the air flow and is supplied to the distribution system.

6. A device (01) for distributing granular material to a plurality of lines (02), comprising:
means (04) for generating a mixed flow from an air flow used as a carrier medium and granular material added to said air flow,
a distributor housing (06) accommodating a rotor (05) mounted rotatably about an axis of rotation (100) and occupying a hollow-cylindrical distributor chamber (03) with a hollow-cylinder axis coinciding with the axis of rotation (100), having a housing wall (07) surrounding the rotor (05) at least in some sections, having an inlet opening (10) spanning a transfer cross-section, and having at least one outlet opening
(11), and having a number, corresponding to the number of lines (02) and/or the number of groups of a plurality of lines (02), of discharge openings (08) arranged in different discharge cross-sections (09) in the housing wall (07), said discharge cross-sections arranged perpendicular to the axis of rotation (100), wherein a line (02) or a group of a plurality of lines (02) is connected to each discharge opening (08),
drive means (12) in order to set the rotor (05) in rotation about the axis of rotation
(100), and
a feed line (13) connecting the means (04) for generating the mixed flow to the inlet opening (10),
wherein the rotor (05) has a number, or integer multiple thereof, corresponding to the number of lines (02) and/or the number of groups of a plurality of lines (02), of sector partition walls (14) protruding radially from the axis of rotation (100) and dividing the hollow-cylindrical distributor chamber (03) into a corresponding number of sector channels (15) extending along the axis of rotation (100).

7. The device according to claim 6, wherein the rotor (05) and/or a slider (17) arranged concentrically with the rotor (05) are/is arranged movably parallel to the axis of rotation (100) in order to shut off individual lines (02) or groups of a plurality of lines (02).

8. The device according to claim 6, wherein the distributor housing (06) surrounds a hollow-cylindrical distributor housing interior corresponding to the distributor chamber (05), the hollow-cylinder axis thereof extending along the axis of rotation (100).

9. The device according to claim 8, wherein the rotor (05) is formed at least in some sections as a star rotor which is open radially outwards away from the axis of rotation (100) and has sector partition walls (14) which separate the adjacent sector channels (15) from one another and protrude radially from the axis of rotation (100).

10. The device according to claim 6, wherein the rotor is designed at least in some sections as a drum rotor (50) which is closed radially outwards away from the axis of rotation (100), and has a tubular or tube-section-like outer ring (51) and sector partition walls (14) which separate the adjacent sector channels (15) from one another and protrude radially from the axis of rotation (100) to the outer ring (51), wherein, per sector channel (15), a discharge window (52) is arranged in the outer ring (51) in an offset manner along the axis of rotation (100) and corresponding to the various discharge cross-sections (09).
